(19) United States
(12) Patent Application Publication
(10) Pub. No.: US 2008/0024012 A1
(43) Pub. Date: Jan. 31, 2008

(54) POWER DEVICE CONFIGURATION WITH ADAPTIVE CONTROL

(76) Inventors: Jaber Abu Qahouq, Beaverton, OR (US); Raviprakash Nagaraj, Tigard, OR (US); Lilly Huang, Portland, OR (US)

Correspondence Address: KACVINSKY LLC;C/O INTELLEVATE, P.O. BOX 52050, MINNEAPOLIS, MN, 55402, US

(21) Appl. No.: 11/460,271

(22) Filed: Jul. 27, 2006

(51) Int. Cl. H02H 3/42

(52) U.S. Cl. 307/126

(57) ABSTRACT

Various embodiments of a power device configuration along with adaptive control mechanisms are described. In one embodiment, for example, an apparatus may comprise multiple power switching devices. One or more of the power switching devices may be selected and/or operated for dynamically controlling the overall or equivalent parasitic effects according to usage conditions or performance under demand. The usage conditions may comprise, for example, load conditions, switching frequency conditions, driver voltage/current, and/or input voltage which affect the power consumption of the power device. Other embodiments are described and claimed.

### BACKGROUND

A conventional power switching device such as metal-oxide semiconductor field effect transistor (MOSFET) device is designed to have fixed parasitic effects due to its simple structure and manufacturing constraints. These fixed parasitic effects are interdependent with the physical gate-drain-source semiconductor structure of the MOSFET device and often cause problems of performance degradation or undesired trade-offs in design for a typical application.

In general, conventional MOSFET devices result in poor performance under most application conditions except a single operation point or narrow range of operation. Therefore, many trade-offs may be required in a design to maintain acceptable performance. For example, a rule-of-thumb in design is to minimize the merit of Q_{g}*R_{ds}_{_{—}}ₒₙ, the product of gate charge (Q_{g}) and drain-to-source resistance at turn-on (R_{ds}_{_{—}}ₒₙ), which works or optimizes only at a certain load current under a fixed gate drive voltage and switching frequency.

### BRIEF DESCRIPTION OF THE DRAWINGS

FIG. 1 illustrates one embodiment of a power device.

FIG. 2 illustrates a graphical representation of the properties Q_{g} and R_{ds}_{_{—}}ₒₙ of a switching device as functions of gate drive voltage.

FIG. 3 illustrates one embodiment of adjusting the physical structure of a switching device.

FIG. 4 illustrates graphical representations of power loss for a power device as a function of average load current or operation switching frequency.

FIG. 5 illustrates one embodiment of a power device comprising a controller.

FIG. 6 illustrates one embodiment of a power device comprising a controller.

FIG. 7 illustrates one embodiment of a power device comprising gate driver circuitry.

FIG. 8 illustrates a graphical representation of adaptive gate drive voltages.

FIG. 9 illustrates one embodiment of a power device comprising uniform cells.

FIG. 10 illustrates one embodiment of a power device comprising non-uniform cells.

FIG. 11 illustrates one embodiment of a logic flow.

FIG. 12 illustrates one embodiment of an article of manufacture.

### DETAILED DESCRIPTION

Various embodiments are directed to a power device configuration with adaptive control. In one embodiment, for example, an apparatus may comprise multiple power switching devices. One or more of the power switching devices may be selected to dynamically control the overall or equivalent parasitic effects according to usage conditions or performance under demand. The usage conditions may comprise, for example, load conditions, voltage across the device, temperature, aging effects, and/or switching frequency conditions which affect the power consumption of the power device.

In some embodiments, the power device configuration may be implemented as an On-the-Fly Adaptive Power Switch (OFAPS) comprising built-in intelligence or control logic to adjust and/or select one or more of the multiple power switching devices based on usage model, operating conditions, and/or performance parameters. In such embodiments, the control logic may be arranged to sense various condition parameters such as current load (I_{load}), root mean square average current (Iᵣₘₛ), current though the drain-to-source (I_{ds}), input voltage (Vᵢₙ), output voltage (Vₒ), drive voltage across the gate-to-source (V_{gs}), voltage applied across the drain-to-source (V_{ds}), switching frequency (F_{sw}), turn-on time (tₒₙ), temperature, and so forth.

In various embodiments, the properties of the one or more power switching devices may be dynamically adjusted based on the usage conditions. The properties may comprise for example, gate charge (Q_{g}), drain-to-source resistance at turn-on (R_{ds}_{_{—}}ₒₙ), switch output capacitance (Cₒₛₛ), reverse recovery charge (Qᵣᵣ), and/or other parasitics and parameters that affect power dissipation.

In some embodiments, the properties of the switching devices may be controlled by adaptively adjusting operation parameters such as the drive voltage and current across and through the gate-to-source (V_{gs}) and the switching frequency (F_{sw}) of a converter, for example. In some embodiments, the properties of the switching devices may be controlled by adaptively adjusting switch structure, such as by changing drivers and/or configuring connections (e.g., in parallel and/or in series) to the switching devices, for example. In some embodiments, the properties of the switching devices may be controlled by adjusting the size and/or physical structures of the switching devices, such as by adjusting channel length and/or channel width, for example. In various implementations, by dynamically adjusting the properties of the one or more power switching devices based on the usage environment, the described embodiments may be used to optimize or maximize system performance, such as power efficiency of a voltage regulator, for an entire operation range.

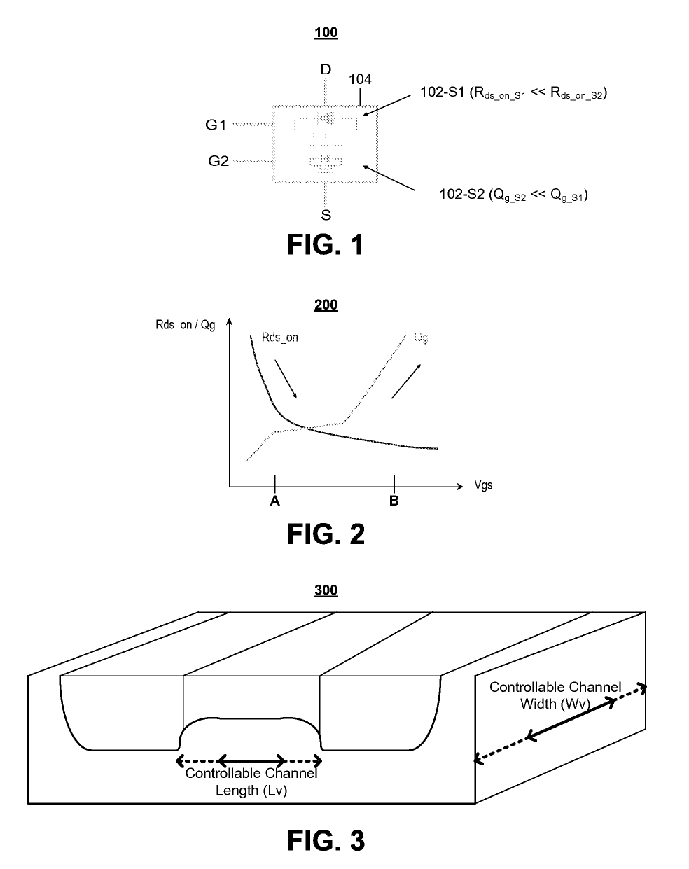

FIG. 1 illustrates one embodiment of a power device 100. As shown in FIG. 1, the power device 100 may comprise multiple power switching devices including, for example, switching devices 102-S1 and 102-S2. In various implementations, the switching devices 102-S1 and 102-S2 may be arranged to operate individually and/or in a shared manner depending on various operating conditions such as load demands, for example. The switching devices 102-S1 and 102-S2 may be implemented on a common semiconductor die, such as semiconductor die 104, or may be implemented on different and/or integrated dies. It can be appreciated that switching devices 102-S1 and 102-S2 are depicted for purposes of illustration and not limitation, and that the power device 100 may employ any number of switching devices in accordance with the described embodiments.

In various embodiments, each of the switching devices 102-S1 and 102-S2 may comprise a field effect transistor (FET) device. In the embodiment of FIG. 1, for example, each of the switching devices 102-S1 and 102-S2 may comprise an n-channel MOSFET device arranged to connect to a drain (D) node and a source (S) node. The switching device 102-S1 may be arranged to connect to a gate (G1) node, and the switching device 102-S2 may be arranged to connect to a gate (G2) node.

Although some embodiments may be described with switching devices (e.g., switching devices 102-S1 and 102-S2) implemented as MOSFET devices for purposes of illustration, and not limitation, it can be appreciated that the embodiments are not limited in this context. For example, the described embodiments may be applicable to various types of switching devices, such as junction FET (JFET) devices, metal semiconductor FET (MESFET) devices, bipolar junction transistor (BJT) devices, or other suitable types of transistors. The transistors may comprise n-type or p-type semiconductor material and may be fabricated using various silicon-based processes such as metal-oxide semiconductor (MOS), complementary MOS (CMOS), bipolar, bipolar CMOS (BiCMOS), and so forth.

When implemented by MOSFET devices, each of the switching devices 102-S1 and 102-S2 may comprise a parasitic body diode and parasitic capacitances such as gate-to-source, gate-to-drain, and drain-to-source parasitic capacitances. In various embodiments, the switching devices 102-S1 and 102-S2 may be arranged to dynamically control the overall or equivalent parasitic effects of the power device 100 by adjusting the properties of the power switching devices 102-S1 and 102-S2.

The power consumption associated with a MOSFET switching device (e.g., switching devices 102-S1 and/or 102-S2) may comprise gate drive loss (P_{gd}), conduction loss (P_{cond}), and switching related loss (P_{sw}). The power consumption associated with P_{gd} generally may involve power dissipation based on gate charge (Q_{g}), the drive voltage across the gate-to-source (V_{gs}), and the switching frequency (F_{sw}) and may be characterized by the following equation:

P_{gd}=Q_{g}*V_{gs}*F_{sw}.

The power consumption associated with P_{cond} generally may involve power dissipation based on the root mean square average current (Iᵣₘₛ) and the switch resistance at turn-on (R_{ds}_{_{—}}ₒₙ) and may be characterized by the following equation:

P_{cond}=Iᵣₘₛ²*R_{ds}_{_{—}}ₒₙ.

The power consumption associated with P_{sw} generally may involve power dissipation based on voltage applied across the drain-to-source (V_{ds}), current though the drain-to-source (I_{ds}), turn-on time (tₒₙ), switching frequency (F_{sw}), switch output capacitance (Cₒₛₛ), and reverse recovery charge (Qᵣᵣ) and may be characterized by the following equation:

P_{sw}αV_{ds}*I_{ds}*tₒₙ*F_{sw}*Cₒₛₛ*Qᵣᵣ.

From the above, it is apparent that P_{sw} can be decreased by reducing properties such as Cₒₛₛ as well as Qᵣᵣ.

Disregarding P_{sw}, the overall power loss (Pₗₒₛₛ) may be approximated by the following equation:

Pₗₒₛₛ˜Q_{g}*V_{gs}*F_{sw}+Iᵣₘₛ²*R_{ds}_{_{—}}ₒₙ.

From the above, it is apparent that Pₗₒₛₛ can be decreased by reducing Q_{g} as well as R_{ds}_{_{—}}ₒₙ. Due to the physical structure of MOSFET devices, however, the properties Q_{g} and R_{ds}_{_{—}}ₒₙ are interdependent and contradictory in nature. For example, decreasing the property R_{ds}_{_{—}}ₒₙ, such as by using a larger die size or channel width between the drain and source, typically results in increasing the property Q_{g}, such as by implementing a larger gate capacitance. Moreover, the properties of Q_{g} and R_{ds}_{_{—}}ₒₙ behave oppositely with respect to the gate drive voltage.

FIG. 2 illustrates a graphical representation 200 showing the properties Q_{g} and R_{ds}_{_{—}}ₒₙ with respect to V_{gs}. As shown, the property Q_{g} tends to increase as V_{gs} increases, and the property R_{ds}_{_{—}}ₒₙ tends to decrease as V_{gs} increases. The graphical representation also illustrates the relationship between the properties Q_{g} and R_{ds}_{_{—}}ₒₙ with respect to particular V_{gs} values. As shown, for the particular V_{gs} value (A), the property Q_{g} is relatively low while the property R_{ds}_{_{—}}ₒₙ is relatively high. For the particular V_{gs} value (B), the property Q_{g} is relatively high, while the property R_{ds}_{_{—}}ₒₙ is relatively low.

Referring again to the embodiment of FIG. 1, the switching device 102-S1 may comprise properties R_{ds}_{_{—}}ₒₙ_{_{—}}_{S1} and Q_{g}_{_{—}}_{S1}, and the switching device 102-S2 may comprise properties R_{ds}_{_{—}}ₒₙ_{_{—}}_{S2} and Q_{g}_{_{—}}_{S2}. In this embodiment, the property R_{ds}_{_{—}}ₒₙ_{_{—}}_{S1} of the switching device 102-S1 may be relatively much lower than the property R_{ds}_{_{—}}ₒₙ_{_{—}}_{S2} of the switching device 102-S2. In this embodiment, the property Q_{g}_{_{—}}_{S2} of the switching device 102-S2 may be relatively much lower than the property Q_{g}_{_{—}}_{S1} of the switching device 102-S1.

In various embodiments, one or more properties of the switching devices 102-S1 and/or 102-S2 may be controlled by adaptively adjusting one or more operation parameters (e.g., I_{load}, Iᵣₘₛ, I_{ds}, Vᵢₙ, Vₒ, V_{gs}, V_{ds}, F_{sw}, tₒₙ, temperature, etc.). By increasing V_{gs}, for example, the property R_{ds}_{_{—}}ₒₙ for a particular switching device may be decreased and the property Q_{g} for the particular switching device may be increased. By decreasing V_{gs}, for example, the property R_{ds}_{_{—}}ₒₙ for a particular switching device may be increased and the property Q_{g} for the particular switching device may be decreased. The embodiments are not limited in this context. For example, in some embodiments, other parasitics and parameters such as Cₒₛₛ and/or Qᵣᵣ properties can be adjusted in a similar manner for the switching devices 102-S1 and/or 102-S2.

In various embodiments, one or more properties of the switching devices 102-S1 and/or 102-S2 may be controlled by adaptively adjusting switch connections. By driving one or more of the switching devices or configuring particular connections (e.g., serial and/or parallel) among the switching devices, for example, the switching devices may operate according to their R_{ds}_{_{—}}ₒₙ and/or Q_{g} properties individually and/or in a shared manner. The embodiments are not limited in this context.

In various embodiments, one or more properties of the switching devices 102-S1 and/or 102-S2 may be controlled by adaptively adjusting the size and/or physical structures (e.g., channel length and/or channel width) of the switching devices. By reducing the channel length and/or increasing the channel width of a particular switching device, for example, the channel resistance and R_{ds}_{_{—}}ₒₙ properties for the particular switching device may be decreased. The embodiments are not limited in this context.

FIG. 3 illustrates one embodiment of adjusting the physical structure a switching device 300. As shown, the switching device 300 may comprise a controllable variable channel length (Lᵥ) and a controllable variable channel width (Wᵥ). By reducing Lᵥ and increasing Wᵥ, for example, channel resistance and R_{ds}_{_{—}}ₒₙ properties may be decreased.

Referring again to the embodiment of FIG. 1, one or more of the switching devices 102-S1 and/or 102-S2 may be selected to dynamically control the overall or equivalent parasitic effects of the power device 100. The selection of the one or more switching devices 102-S1 and/or 102-S2 may be made according to usage conditions or performance under demand. In various embodiments, the usage conditions may comprise, for example, load conditions and/or switching frequency conditions which affect the power consumption of the power device. In such embodiments, a selection may be made between the switching device 102-S1 and the switching device 102-S2 according to one or more usage condition parameters (e.g., I_{load}, Iᵣₘₛ, I_{ds}, Vᵢₙ, Vₒ, V_{gs}, V_{ds}, F_{sw}, tₒₙ, temperature, etc.).

In one embodiment, the usage conditions or performance under demand may comprise a light load condition. For a light load condition, the condition parameter Iᵣₘₛ is relatively low. In this case, therefore, the switching device 102-S2 is selected because the property Q_{g}_{_{—}}_{S2} of the switching device 102-S2 is relatively much lower than the property Q_{g}_{_{—}}_{S1} of the switching device 102-S1. By selecting the switching device having the much lower Q_{g} property, the power consumption associated with P_{gd}, which depends on Q_{g}, will be reduced. Accordingly, under a light load condition, the power loss effectively may be reduced to Pₗₒₛₛ˜Iᵣₘₛ²*R_{ds}_{_{—}}ₒₙ. While the property R_{ds}_{_{—}}ₒₙ_{_{—}}_{S2} of the switching device 102-S2 may be higher than the property R_{ds}_{_{—}}ₒₙ_{_{—}}_{S1} of the switching device 102-S1, the reduction in P_{gd} and the relatively small condition parameter Iᵣₘₛ may be sufficient to reduce or minimize the total power loss as compared to the conventional approach.

In one embodiment, the usage conditions or performance under demand may comprise a heavy load condition. For a heavy load condition, the condition parameter Iᵣₘₛ is relatively high. In this case, therefore, the switching device 102-S1 is selected because the property R_{ds}_{_{—}}ₒₙ_{_{—}}_{S1} of the switching device 102-S1 is relatively much lower than the property R_{ds}_{_{—}}ₒₙ_{_{—}}_{S2} of the switching device 102-S2. By selecting the switching device having the relatively lower R_{ds}_{_{—}}ₒₙ property, the power consumption associated with P_{cond}, which depends on R_{ds}_{_{—}}ₒₙ, will be reduced. While the property Q_{g}_{_{—}}_{S1} of the switching device 102-S1 may be higher than the property Q_{g}_{_{—}}_{S2} of the switching device 102-S2, the reduction in P_{cond} may be sufficient to reduce or minimize the total power loss as compared to the conventional approach.

In one embodiment, the usage conditions or performance under demand may comprise a low switching frequency condition. For a low switching frequency condition, the condition parameter F_{sw} is relatively low. In this case, therefore, the switching device 102-S1 is selected because the property R_{ds}_{_{—}}ₒₙ_{_{—}}_{S1} of the switching device 102-S1 is relatively much lower than the property R_{ds}_{_{—}}ₒₙ_{_{—}}_{S2} of the switching device 102-S2. By selecting the switching device having the relatively lower R_{ds}_{_{—}}ₒₙ property, the power consumption associated with P_{cond}, which depends on R_{ds}_{_{—}}ₒₙ, will be reduced. Accordingly, under a low switching frequency condition, the power loss effectively may be reduced to Pₗₒₛₛ˜Q_{g}*V_{g}*F_{sw}. While the property Q_{g}_{_{—}}ₛ₁ of the switching device 102-S1 may be much higher than the property R_{ds}_{_{—}}ₒₙ_{_{—}}_{S1} of the switching device 102-S2, the reduction in P_{cond} and the relatively small condition parameter F_{sw} may be sufficient to reduce or minimize the total power loss as compared to the conventional approach.

In one embodiment, the usage conditions or performance under demand may comprise a high switching frequency condition. For a high frequency switching condition, the condition parameter F_{sw} is relatively high. In this case, therefore, the switching device 102-S2 is selected because the property Q_{g}_{_{—}}_{S2} of the switching device 102-S2 is relatively much lower than the property Q_{g}_{_{—}}_{S1} of the switching device 102-S1. By selecting the switching device having the much lower Q_{g} property, the power consumption associated with P_{gd}, which depends on Q_{g}, will be reduced. While the property R_{ds}_{_{—}}ₒₙ_{_{—}}_{S2} of the switching device 102-S2 may be higher than the property R_{ds}_{_{—}}ₒₙ_{_{—}}_{S1} of the switching device 102-S1, the reduction in P_{gd} may be sufficient to reduce or minimize the total power loss as compared to the conventional approach.

As described above, in various embodiments, the power device 100 may be configured with multiple switching devices 102-S1 and 102-S2 having properties that can be dynamically adapted to result in either lowest R_{ds}_{_{—}}ₒₙ or smallest Q_{g} based on the performance under demand or usage conditions. The embodiments, however, are not limited in this context. For example, in some embodiments, other switching parasitics that affect switching losses can be controlled and optimized for certain conditions in addition to the power dissipation associated with gate loss and conduction loss.

Although some embodiments may be described with usage conditions comprising high and low conditions for purposes of illustration, and not limitation, it can be appreciated that the embodiments are not limited in this context. For example, the described embodiments may be applicable to any number of usage conditions and/or optimization levels.

In various implementations, the flexibility of the power device 100 may directly benefit the efficiency of a power system, especially for load adaptive power conversion and distribution. In some implementations, for example, the power device 100 may be integrated in various systems or devices such as a voltage regulator (e.g., dc/dc), power management integrated circuit (PMIC), reconfigurable power distribution platform, power converter, power switcher, and so forth. The power device 100 may provide on-die power delivery for silicon products such as a processor (e.g., many-core processor) and/or a chipset.

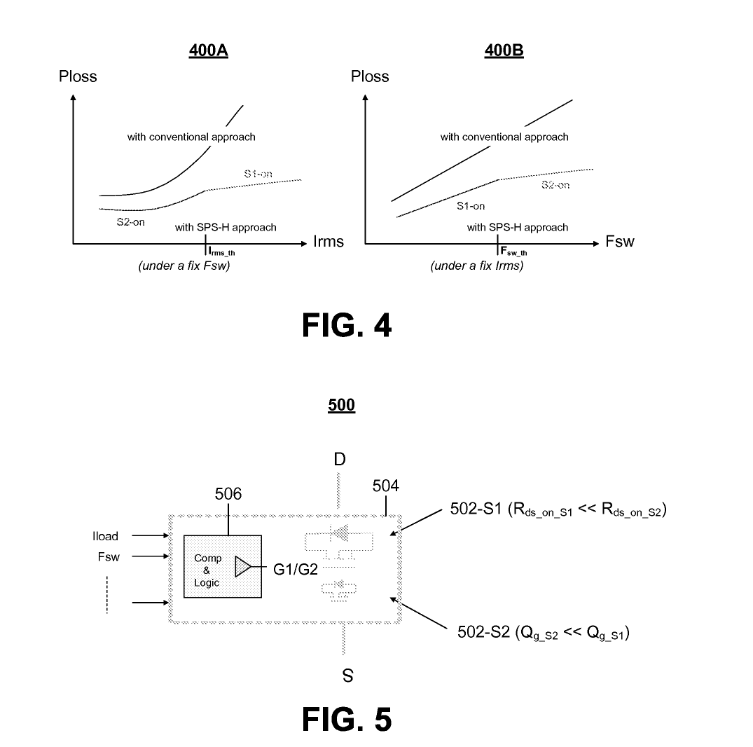

FIG. 4 illustrates graphical representations of power loss for one embodiment of a power device such as the power device 100 of FIG. 1. The graphical representation 400A depicts Pₗₒₛₛ with respect to Iᵣₘₛ for a fixed F_{sw}, and the graphical representation 400B depicts Pₗₒₛₛ with respect to F_{sw} for a fixed Iᵣₘₛ.

As shown in the graphical representation 400A, the switching device 102-S2 is on for Iᵣₘₛ values below the threshold value Iᵣₘₛ_{_{—}}ₜₕ, and the switching device 102-S1 is on for Iᵣₘₛ values above the threshold value Iᵣₘₛ_{_{—}}ₜₕ. The value Iᵣₘₛ_{_{—}}ₜₕ may comprise, for example, a predetermined current at which to switch between or among switching devices. In this embodiment, the property R_{ds}_{_{—}}ₒₙ_{_{—}}_{S1} of the switching device 102-S1 may be relatively much lower than the property R_{ds}_{_{—}}ₒₙ_{_{—}}_{S2} of the switching device 102-S2, and the property Q_{g}_{_{—}}_{S2} of the switching device 102-S2 may be relatively much lower than the property Q_{g}_{_{—}}_{S1} of the switching device 102-S1. The graphical representation 400A demonstrates a substantial reduction in Pₗₒₛₛ relative to the conventional approach.

As shown in the graphical representation 400B, the switching device 102-S1 is on for F_{sw} values below the threshold value F_{sw}_{_{—}}ₜₕ, and the switching device 102-S2 is on for F_{sw} values above the threshold value F_{sw}_{_{—}}ₜₕ. The value F_{sw}_{_{—}}ₜₕ may comprise, for example, a predetermined switching frequency at which to switch between or among switching devices. Again, the property R_{ds}_{_{—}}ₒₙ_{_{—}}_{S1} of the switching device 102-S1 may be relatively much lower than the property R_{ds}_{_{—}}ₒₙ_{_{—}}_{S2} of the switching device 102-S2, and the property Q_{g}_{_{—}}_{S2} of the switching device 102-S2 may be relatively much lower than the property Q_{g}_{_{—}}_{S1} of the switching device 102-S1. The graphical representation 400B demonstrates a substantial reduction in Pₗₒₛₛ relative to the conventional approach.

FIG. 5 illustrates one embodiment of a power device 500. As shown in FIG. 5, the power device 500 may comprise multiple power switching devices including, for example, switching devices 502-S1 and 502-S2. In various implementations, the switching devices 502-S1 and 502-S2 may be arranged to operate individually and/or in a shared manner depending on various operating conditions such as load conditions, for example. The switching devices 502-S1 and 502-S2 may be implemented on a common semiconductor die, such as semiconductor die 504, or may be implemented on different and/or integrated dies. It can be appreciated that switching devices 502-S1 and 502-S2 are depicted for purposes of illustration and not limitation, and that the power device 500 may employ any number of switching devices in accordance with the described embodiments.

In various embodiments, the switching devices 102-S1 and 102-S2 may comprise FET devices such as n-channel MOSFET devices arranged to connect to a drain (D) node, a source (S) node, and a selectable gate (G1/G2) node. In this embodiment, the property R_{ds}_{_{—}}ₒₙ_{_{—}}_{S1} of the switching device 502-S1 may be relatively much lower than the property R_{ds}_{_{—}}ₒₙ_{_{—}}_{S2} of the switching device 502-S2, and the property Q_{g}_{_{—}}_{S2} of the switching device 502-S2 may be relatively much lower than the property Q_{g}_{_{—}}_{S1} of the switching device 502-S1.

In some embodiments, the power device 500 may be implemented as an On-the-Fly Adaptive Power Switch (OFAPS) comprising built-in intelligence or a controller 506 to select one or more of the multiple power switching devices 502-S1 and 502-S2 based on detected usage conditions. In such embodiments, the controller 506 may be arranged to sense various usage condition parameters (e.g., I_{load}, Iᵣₘₛ, I_{ds}, Vᵢₙ, Vₒ, V_{gs}, V_{ds}, F_{sw}, tₒₙ, temperature, etc.). The controller 506 may be implemented on the semiconductor die 504 or may be implemented on a different and/or integrated die.

The controller 506 may comprise, for example, one or more logic devices and/or logic comprising instructions, data, and/or code to be executed by a logic device. Examples of a logic device include, without limitation, a central processing unit (CPU), microcontroller, microprocessor, general purpose processor, dedicated processor, chip multiprocessor (CMP), media processor, digital signal processor (DSP), network processor, co-processor, input/output (I/O) processor, application specific integrated circuit (ASIC), field programmable gate array (FPGA), programmable logic device (PLD), and so forth. In various implementations, a logic device may include one or more processing cores arranged to execute digital logic and/or provide for multiple threads of execution. The logic device also may comprise memory implemented by one or more types of computer-readable storage media such as volatile or non-volatile memory, removable or non-removable memory, erasable or non-erasable memory, writeable or re-writeable memory, and so forth.

In various embodiments, the controller 506 may comprise intelligent gate driver circuitry and control logic to drive the gate nodes (G1/G2) by sensing operating condition parameters (e.g., I_{load}, Iᵣₘₛ, I_{ds}, Vᵢₙ, Vₒ, V_{gs}, V_{ds}, F_{sw}, tₒₙ, temperature, etc.) and then automatically determining which of the one or more switching devices 502-S1 and 502-S2 to turn on/off in order to achieve the minimum power consumption under specific usage conditions.

In various embodiments, the controller 506 may be arranged to dynamically control the overall or equivalent parasitic effects of the power device 500 by adjusting the properties (e.g., Q_{g}, R_{ds}_{_{—}}ₒₙ, Cₒₛₛ, Qᵣᵣ, etc.) of the power switching devices 502-S1 and 502-S2. For example, the controller 506 may be arranged to control one or more properties of the switching devices 502-S1 and/or 502-S2 by adaptively adjusting one or more operation parameters, by adaptively adjusting switch connections, and/or by adaptively adjusting the size and/or physical structures (e.g., channel length and/or channel width) of the switching devices. The embodiments are not limited in this context.

The controller 506 may be arranged to select one or more of the switching devices 502-S1 and/or 502-S2 according to usage conditions or performance under demand. In various embodiments, the usage conditions may comprise, for example, load conditions and/or switching frequency conditions which affect the power consumption of the power device. In such embodiments, a selection may be made between the switching devices 502-S1 and the switching device 502-S2 according to one or more usage condition parameters (e.g., I_{load}, Iᵣₘₛ, I_{ds}, Vᵢₙ, Vₒ, V_{gs}, V_{ds}, F_{sw}, tₒₙ, temperature, etc.).

For example, the usage conditions or performance under demand may comprise a light load condition. For a light load condition, the condition parameter Iᵣₘₛ is relatively low. In this case, therefore, the controller 506 may automatically selected the switching device 502-S2 because the property Q_{g}_{_{—}}_{S2} of the switching device 502-S2 is relatively much lower than the property Q_{g}_{_{—}}_{S1} of the switching device 502-S1.

The usage conditions or performance under demand may comprise a heavy load condition. For a heavy load condition, the condition parameter Iᵣₘₛ is relatively high. In this case, therefore, the controller 506 may automatically select the switching device 502-S1 because the property R_{ds}_{_{—}}ₒₙ_{_{—}}_{S1} of the switching device 502-S1 is relatively much lower than the property R_{ds}_{_{—}}ₒₙ_{_{—}}_{S2} of the switching device 502-S2.

The usage conditions or performance under demand may comprise a low switching frequency condition. For a low switching frequency condition, the condition parameter F_{sw} is relatively low. In this case, therefore, the controller 506 may automatically select the switching device 502-S1 because the property R_{ds}_{_{—}}ₒₙ_{_{—}}_{S1} of the switching device 502-S1 is relatively much lower than the property R_{ds}_{_{—}}ₒₙ_{_{—}}_{S2} of the switching device 502-S2.

The usage conditions or performance under demand may comprise a high switching frequency condition. For a high frequency switching condition, the condition parameter F_{sw} is relatively high. In this case, therefore, the controller 506 may automatically select the switching device 102-S2 because the property Q_{g}_{_{—}}_{S2} of the switching device 502-S2 is relatively much lower than the property Q_{g}_{_{—}}_{S1} of the switching device 502-S1.

Unlike a conventional power switch, the power controller 500 and switching devices 502-S1 and 502-S2 demonstrate the functionality of both power and control. The power device 500 may operate actively (rather than passively) to reflect the change of a specific loading condition by tracking a load or the variation of the load and then automatically selecting the optimal mode or stage for a corresponding operation. In various implementations, the flexibility and intelligence of the power device 500 may enhance the performances of a power system, such as power efficiency and device thermal, and may achieve adaptive platform power conversion and distribution.

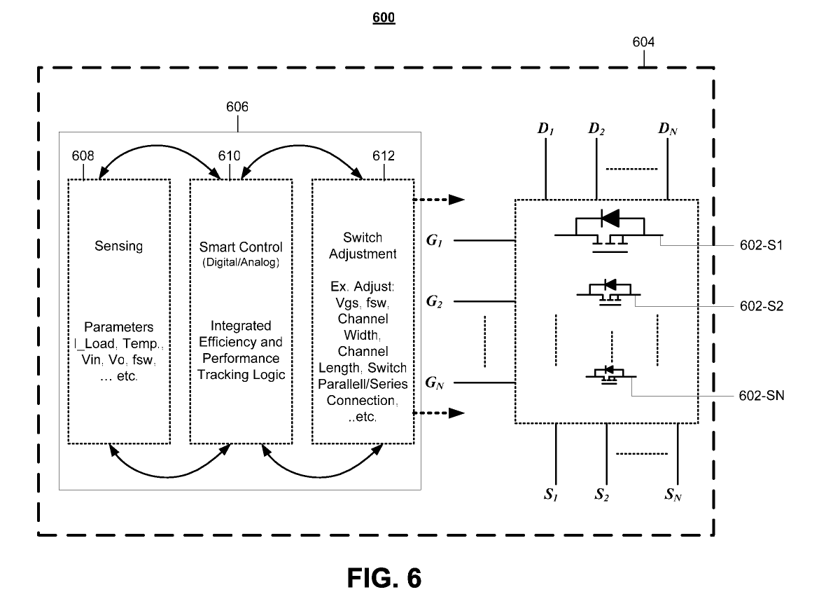

FIG. 6 illustrates one embodiment of a power device 600. As shown in FIG. 6, the power device 600 may comprise multiple power switching devices including, for example, switching devices 602-S1, 602-S2, and 602-SN, where N represents any positive integer value limited only by size and/or performance constraints of the power device 600. In various implementations, the switching devices 602-S1, 602-S2, and 602-SN may be arranged to operate individually and/or in a shared manner depending on various operating conditions such as load conditions, for example. The switching devices 602-S1, 602-S2, and 602-SN may be implemented on a common semiconductor die, such as semiconductor die 604, or may be implemented on different and/or integrated dies.

In various embodiments, the switching devices 602-S1, 602-S2, and 602-SN may comprise FET devices such as n-channel MOSFET devices arranged to connect to corresponding drain nodes (D₁, D₂, D_{N}), source nodes (S₁, S₂, S_{N}), and selectable gate nodes (G₁, G₂, G_{N}). In this embodiment, the property R_{ds}_{_{—}}ₒₙ_{_{—}}_{S1} of the switching device 602-S1 may be relatively lower than the property R_{ds}_{_{—}}ₒₙ_{_{—}}_{S2} of the switching device 602-S2, and the property R_{ds}_{_{—}}ₒₙ_{_{—}}_{S2} of the switching device 602-S2 may be relatively lower than the property R_{ds}_{_{—}}ₒₙ_{_{—}}_{SN} of the switching device 602-SN. The property Q_{g}_{_{—}}_{S2} of the switching device 602-S2 may be relatively lower than the property Q_{g}_{_{—}}_{S1} of the switching device 602-S1, and the property Q_{g}_{_{—}}_{SN} of the switching device 602-SN may be relatively lower than the property Q_{g}_{_{—}}_{S2} of the switching device 602-S2.

The power device 600 may comprise a controller 606 to select one or more of the multiple power switching devices 602-S1, 602-S2, and 602-SN based on detected usage conditions. The controller 606 may be implemented on the semiconductor die 604 or may be implemented on a different and/or integrated die. As depicted, the controller 606 may be illustrated and described as comprising several separate functional components and/or modules. Although FIG. 6 may illustrate the controller 606 as comprising separate modules, each performing various operations, it can be appreciated that in some embodiments, the operations performed by various modules may be combined and/or separated for a given implementation and may be performed by a greater or fewer number of modules.

The modules may be implemented, for example, by various logic devices and/or logic comprising instructions, data, and/or code to be executed by a logic device. In various implementations, the components and/or modules may be connected and/or logically coupled by one or more communications media such as, for example, wired communication media, wireless communication media, or a combination of both, as desired for a given implementation. Although described in terms of components and/or modules to facilitate description, it is to be appreciated that such components and/or modules may be implemented by one or more hardware components, software components, and/or combination thereof.

The controller 606 may comprise a sensing module 608, a smart (digital/analog) control module 610, and a switch adjustment module 612. In various embodiments, the sensing module 608 may be arranged to sense various usage condition parameters (e.g., I_{load}, Iᵣₘₛ, I_{ds}, Vᵢₙ, Vₒ, V_{gs}, V_{ds}, F_{sw}, tₒₙ, temperature, etc.).

The control module 610 may comprise intelligent gate driver circuitry and control logic to drive the gate nodes (G₁, G₂, G_{N}) based on sensed usage or operating condition parameters and then automatically determining which of the one or more switching devices 602-S1, 602-S2, and/or 602-SN to turn on/off in order to achieve the minimum power consumption under specific usage conditions.

The control module 610 may be arranged to select one or more of the switching devices 602-S1, 602-S2, and/or 602-SN according to usage conditions or performance under demand. In various embodiments, the usage conditions may comprise, for example, load conditions and/or switching frequency conditions which affect the power consumption of the power device. In such embodiments, a selection may be made between the switching devices 602-S1, 602-S2, and/or 602-SN according to one or more usage condition parameters (e.g., I_{load}, Iᵣₘₛ, I_{ds}, Vᵢₙ, Vₒ, V_{gs}, V_{ds}, F_{sw}, tₒₙ, temperature, etc.).

The control module 610 may operate actively to reflect the change of a specific loading condition by tracking a load or the variation of the load and then automatically selecting the optimal mode or stage for a corresponding operation. For example, the usage conditions or performance under demand may comprise a light load condition and/or a high switching frequency condition, and the control module 610 may automatically select the switching device with the lowest Q_{g} property. The usage conditions may comprise a heavy load condition and/or a low frequency condition, and the control module 610 may automatically select the switching device having the lowest R_{ds}_{_{—}}ₒₙ property.

The switch adjustment module 612 may be arranged to dynamically control the overall or equivalent parasitic effects of the power device 600 by adjusting the properties (e.g., Q_{g}, R_{ds}_{_{—}}ₒₙ, Cₒₛₛ, Qᵣᵣ, etc.) of the power switching devices 602-S1, 602-S2, and 602-SN. For example, the switch adjustment module 612 may be arranged to control one or more properties of the switching devices 602-S1, 602-S2, and/or 602-SN by adaptively adjusting one or more operation parameters, by adaptively adjusting switch connections, and/or by adaptively adjusting the physical structures (e.g., channel length and/or channel width) of the switching devices. The embodiments are not limited in this context.

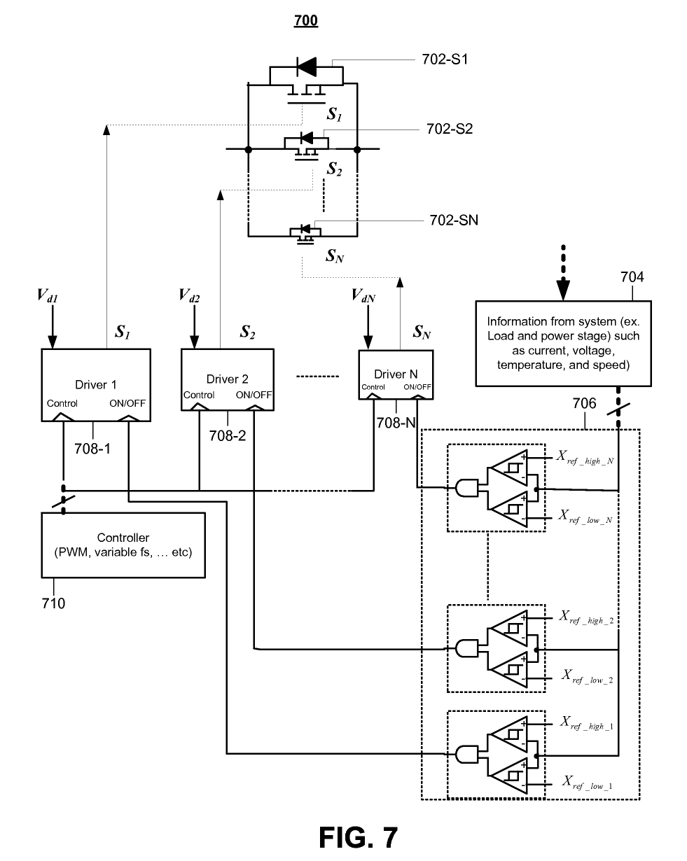

FIG. 7 illustrates one embodiment of a power device 700. As shown in FIG. 7, the power device 700 may comprise multiple power switching devices including, for example, switching devices 702-S1, 702-S2, and 702-SN, where N represents any positive integer value limited only by size and/or performance constraints of the power device 700. In various implementations, the switching devices 702-S1, 702-S2, and 702-SN may be arranged to operate individually and/or in a shared manner depending on various operating conditions such as load conditions, for example. The switching devices 702-S1, 702-S2, and 702-SN may be implemented on a common semiconductor die or may be implemented on different and/or integrated dies.

In various embodiments, the switching devices 702-S1, 702-S2, and 702-SN may comprise FET devices such as n-channel MOSFET devices or other suitable transistors. In this embodiment, the property R_{ds}_{_{—}}ₒₙ_{_{—}}_{S1} of the switching device 702-S1 may be relatively lower than the property R_{ds}_{_{—}}ₒₙ_{_{—}}_{S2} of the switching device 702-S2, and the property R_{ds}_{_{—}}ₒₙ_{_{—}}_{S2} of the switching device 702-S2 may be relatively lower than the property R_{ds}_{_{—}}ₒₙ_{_{—}}_{SN} of the switching device 702-SN. The property Q_{g}_{_{—}}_{S2} of the switching device 702-S2 may be relatively lower than the property Q_{g}_{_{—}}_{S1} of the switching device 702-S1, and the property Q_{g}_{_{—}}_{SN} of the switching device 702-SN may be relatively lower than the property Q_{g}_{_{—}}_{S2} of the switching device 702-S2.

In various embodiments, the power device 700 may comprise intelligent gate driver circuitry for sensing operating condition parameters (e.g., I_{load}, Iᵣₘₛ, I_{ds}, Vᵢₙ, Vₒ, V_{gs}, V_{ds}, F_{sw}, tₒₙ, temperature, etc.) and then automatically determining which of the one or more switching devices 702-S1, 702-S2, and/or 702-SN to turn on/off in order to achieve the minimum power consumption under specific usage conditions.

As shown, the power device 700 may comprise a sensing module 704 arranged to receive or sense various system information such as load and/or power stage information. In various embodiments, the system information may comprise one or more usage condition parameters such as current (e.g., I_{load}, Iᵣₘₛ, I_{ds}) voltage (e.g., Vᵢₙ, Vₒ, V_{gs}, V_{ds},), speed (e.g., F_{sw}, tₒₙ,), temperature, and so forth.

The power device 700 may comprise comparison circuitry 706 arranged to determine usage conditions based on the system information. The determination may be made, for example, by comparing one or more usage condition parameters to predetermined reference values (e.g., X_{ref}_{_{—}}_{high}_{_{—}}₁, X_{ref}_{_{—}}_{low}_{_{—}}₁, X_{ref}_{_{—}}_{high}_{_{—}}₂, X_{ref}_{_{—}}_{low}_{_{—}}₂, X_{ref}_{_{—}}_{high}_{_{—}}_{N}, X_{ref}_{_{—}}_{low}_{_{—}}_{N}). In various embodiments, the usage conditions may comprise, for example, load conditions and/or switching frequency conditions which affect the power consumption of the power device.

The power device 700 may comprise drivers 708-1, 708-2, and 708-N driven by corresponding voltages V_{d1}, V_{d2}, and V_{dN}, and arranged to turn on/off in response to the determined usage conditions. The drivers 708-1, 708-2, and 708-N also may receive control signals from a controller 710 implemented, for example, by a pulse width modulator (PWM), variable frequency switch, or other logic device and/or control logic. Accordingly, a determination and/or selection may be made as to which of the one or more switching devices 702-S1, 702-S2, and/or 702-SN to turn on/off in order to achieve the minimum power consumption under specific usage conditions.

In various embodiments, the gate driver circuitry may be arranged to apply adaptive gate voltages to each of the switching devices 702-S1, 702-S2, and/or 702-SN based on the usage condition. By adaptively controlling the drive-voltage levels, the gate drive voltages V_{d1}, V_{d2}, and V_{dN} may be the same or may differ in order to optimize the gate voltages and/or current applied to each of the switching devices 702-S1, 702-S2, and/or 702-SN. In various implementations, the values of the gate drive voltages (e.g., V_{d1}, V_{d2}, and V_{dN}), the applied gate voltages, and/or the applied current may be dynamically adjusted on-the-fly.

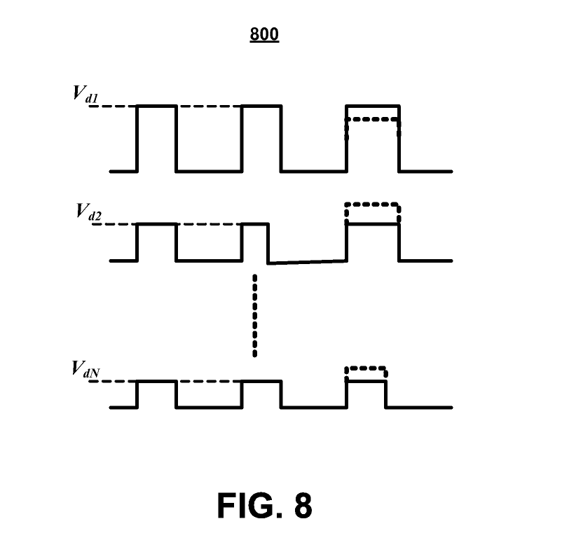

FIG. 8 illustrates a graphical representation 800 of adaptive gate drive voltages. As shown, the gate drive voltages V_{d1}, V_{d2}, and V_{dN} may be controlled to provide different adaptive drive-voltage levels. In one embodiment, the voltages V_{d1}, V_{d2}, and V_{dN} may be dynamically adjusted on-the-fly to optimize the gate voltages and/or current applied to each of the switching devices 702-S1, 702-S2, and/or 702-SN. The embodiments are not limited in this context.

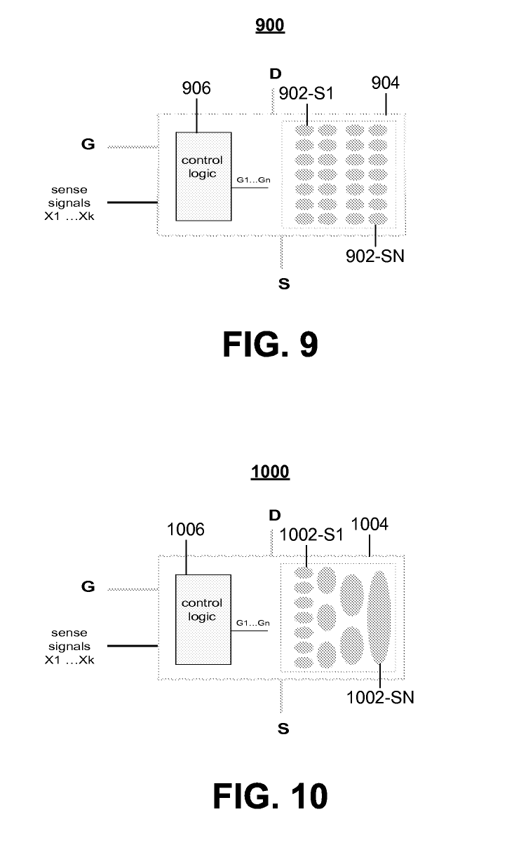

FIG. 9 illustrates one embodiment of a power device 900. As shown in FIG. 9, the power device 900 may comprise multiple power switching devices including, for example, switching devices 902-S1-SN, where N represents any positive integer value limited only by size and/or performance constraints of the power device 900. In various implementations, the switching devices 902-S1-SN may be arranged to operate individually and/or in a shared manner depending on various operating conditions such as load conditions, for example. The switching devices 902-S1-SN may be implemented on a common semiconductor die 904 or implemented on different and/or integrated dies.

The power device 900 may comprise a controller 906 implemented on the semiconductor die 904 or implemented on a different and/or integrated die. The controller 906 may be arranged to select one or more of the multiple power switching devices 902-S1-SN based on usage conditions determined from one or more sensed usage condition signals (X₁ . . . Xₖ). In various embodiments, sensed usage condition signals X₁ . . . Xₖ may comprise one or more parameters such as I_{load}, Iᵣₘₛ, Vᵢₙ, Vₒ, F_{sw}, temperature, and so forth.

In this embodiment, the switching devices 902-S1-SN may comprise uniform cells, each identical in electrical property. Depending on the operation conditions, the controller 906 may drive gates (G₁ . . . Gₙ) to dynamically turn on/off one or multiple cells in parallel to maximize system performance such as power consumption and/or operating efficiency. The embodiments are not limited in this context.

FIG. 10 illustrates one embodiment of a power device 1000. As shown in FIG. 10, the power device 1000 may comprise multiple power switching devices including, for example, switching devices 1002-S1-SN, where N represents any positive integer value limited only by size and/or performance constraints of the power device 1000. In various implementations, the switching devices 1002-S1-SN may be arranged to operate individually and/or in a shared manner depending on various operating conditions such as load conditions, for example. The switching devices 1002-S1-SN may be implemented on a common semiconductor die 1004 or implemented on different and/or integrated dies.

The power device 1000 may comprise a controller 1006 implemented on the semiconductor die 1004 or implemented on a different and/or integrated die. The controller 1006 may be arranged to select one or more of the multiple power switching devices 1002-S1-SN based on usage conditions determined from one or more sensed usage condition signals (X₁ . . . Xₖ). In various embodiments, sensed usage condition signals X₁ . . . Xₖ may comprise one or more parameters such as I_{load}, Iᵣₘₛ, Vᵢₙ, Vₒ, F_{sw}, temperature, and so forth.

In this embodiment, the switching devices 1002-S1-SN may comprise multiple non-uniform cells. In this embodiment, one or more cells may comprise different electrical properties such as different R_{ds}_{_{—}}ₒₙ and/or Q_{g} properties, for example. Depending on the operation conditions, the controller 906 may drive gates (G₁ . . . Gₙ) to dynamically turn on/off one or multiple cells in parallel to maximize system performance such as power consumption and/or operating efficiency. The embodiments are not limited in this context.

Operations for various embodiments may be further described with reference to the following figures and accompanying examples. Some of the figures may include a logic flow. It can be appreciated that an illustrated logic flow merely provides one example of how the described functionality may be implemented. Further, a given logic flow does not necessarily have to be executed in the order presented unless otherwise indicated. In addition, a logic flow may be implemented by a hardware element, a software element executed by a processor, or any combination thereof. The embodiments are not limited in this context.

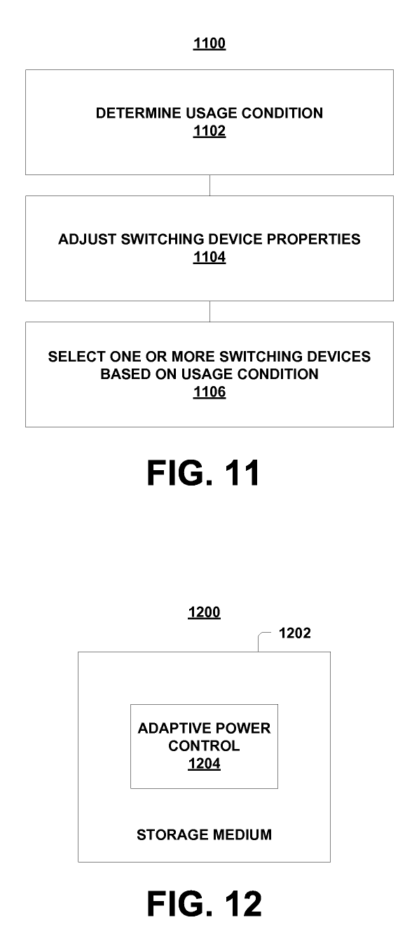

FIG. 11 illustrates one embodiment of a logic flow 1100 for adaptive power control. In various embodiments, the logic flow 1100 may be performed by various systems and/or devices and may be implemented as hardware, software, and/or any combination thereof, as desired for a given set of design parameters or performance constraints. For example, the logic flow 1100 may be implemented by a logic device (e.g., power controller) and/or logic (e.g., adaptive power control logic) comprising instructions, data, and/or code to be executed by a logic device. For purposes of illustration, and not limitation, the logic flow 1100 is described with reference to FIG. 1. The embodiments are not limited in this context.

The logic flow 1100 may comprise determining a usage condition (block 1102). In various embodiments, a usage condition may be determined by sensing various usage condition parameters such as I_{load}, Iᵣₘₛ, Vᵢₙ, Vₒ, F_{sw}, temperature, and so forth. In various implementations, the usage conditions may comprise, for example, load conditions and/or switching frequency conditions which affect the power consumption of the power device. The usage condition may be determined actively to reflect the change of a specific loading condition by tracking a load or the variation of the load. The embodiments are not limited in this context.

The logic flow may comprise adjusting the properties of the power switching devices (block 1104). In various embodiments, the properties of the switching devices 102-S1 and/or 102-S2 may be adjusted to dynamically control the overall or equivalent parasitic effects of the power device 100. In various implementations, one or more properties (e.g., Q_{g}, R_{ds}_{_{—}}ₒₙ, Cₒₛₛ, Qᵣᵣ, etc.) of the switching devices 102-S1 and/or 102-S2 may be controlled by adaptively adjusting one or more operation parameters (e.g., I_{load}, Iᵣₘₛ, I_{ds}, Vᵢₙ, Vₒ, V_{gs}, V_{ds}, F_{sw}, tₒₙ, temperature, etc.), by adaptively adjusting switch connections, and/or by adaptively adjusting the physical structures (e.g., channel length and/or channel width) of the switching devices. The embodiments are not limited in this context.

The logic flow 1100 may comprise selecting one or more of the switching devices according to the usage condition (block 1106). In various embodiments, one or more of the switching devices 102-S1 and/or 102-S2 may be selected according to a usage condition or performance under demand. In various implementations, the selection may be made automatically to determine which of the one or more switching devices 102-S1 and/or 102-S2 to turn on/off in order to achieve the minimum power consumption under specific usage conditions. For example, the usage conditions or performance under demand may comprise a light load condition and/or a high switching frequency condition, and the switching device with the lowest Q_{g} property may be selected. The usage conditions may comprise a heavy load condition and/or a low frequency condition, and the switching device having the lowest R_{ds}_{_{—}}ₒₙ property may be selected. The embodiments are not limited in this context.

FIG. 12 illustrates one embodiment of an article of manufacture 1200. As shown, the article 1200 may comprise a machine-readable storage medium 1202 to store adaptive power control logic 1204 for performing various operations in accordance with the described embodiments. In various embodiments, the article 1200 may be implemented by various systems, nodes, and/or modules.

The article 1200 and/or machine-readable storage medium 1202 may include one or more types of computer-readable storage media capable of storing data, including volatile memory or, non-volatile memory, removable or non-removable memory, erasable or non-erasable memory, writeable or re-writeable memory, and so forth. Examples of a machine-readable storage medium may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other type of computer-readable storage media suitable for storing information. Moreover, any media involved with downloading or transferring a computer program from a remote computer to a requesting computer carried by data signals embodied in a carrier wave or other propagation medium through a communication link (e.g., a modem, radio or network connection) is considered computer-readable storage media.

The article 1200 and/or machine-readable storage medium 1202 may store adaptive power control logic 1204 comprising instructions, data, and/or code that, if executed by a machine, may cause the machine to perform a method and/or operations in accordance with the described embodiments. Such a machine may include, for example, any suitable processing platform, computing platform, computing device, processing device, computing system, processing system, computer, processor, or the like, and may be implemented using any suitable combination of hardware and/or software.

The adaptive power control logic 1204 may comprise, or be implemented as, software, a software module, an application, a program, a subroutine, instructions, an instruction set, computing code, words, values, symbols or combination thereof. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within computing system registers and/or memories into other data similarly represented as physical quantities within the computing system memories, registers or other such information storage, transmission or display devices.

It is also worthy to note that any reference to “one embodiment” or “an embodiment” means that a particular feature, structure, or characteristic described in connection with the embodiment is included in at least one embodiment. Thus, appearances of the phrases “in one embodiment” or “in an embodiment” in various places throughout the specification are not necessarily all referring to the same embodiment. Furthermore, the particular features, structures or characteristics may be combined in any suitable manner in one or more embodiments.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus comprising:
multiple power switching devices, one or more of the multiple power switching devices to be selected to dynamically control equivalent parasitic effects of the apparatus according to a usage condition.

2. The apparatus of claim 1, the usage condition comprising at least one of current load (I_{load}), root mean square average current (Iᵣₘₛ), current though the drain-to-source (I_{ds}), input voltage (Vᵢₙ), output voltage (Vₒ), drive voltage across the gate-to-source (V_{gs}), voltage applied across the drain-to-source (V_{ds}), switching frequency (F_{sw}), turn-on time (tₒₙ), and temperature.

3. The apparatus of claim 1, wherein one or more properties of one or more of the power switching devices are dynamically adjusted based on the usage condition.

4. The apparatus of claim 3, the one or more properties comprising at least one of gate charge (Q_{g}), drain-to-source resistance at turn-on (R_{ds}_{_{—}}ₒₙ), switch output capacitance (Cₒₛₛ), and reverse recovery charge (Qᵣᵣ).

5. The apparatus of claim 1, further comprising a controller to select one or more of the multiple power switching devices based on the usage condition.

6. The apparatus of claim 1, further comprising gate driver circuitry to apply adaptive gate voltages to each of the multiple power switching devices based on the usage condition.

7. The apparatus of claim 1, the multiple power switching devices comprising:
a first switching device having a first gate charge (Q_{g}) property and a first drain-to-source resistance at turn-on (R_{ds}_{_{—}}ₒₙ) property; and
a second switching device having a second Q_{g} property and a second R_{ds}_{_{—}}ₒₙ property,
wherein the first R_{ds}_{_{—}}ₒₙ property is relatively lower than the second R_{ds}_{_{—}}ₒₙ property, and the second Q_{g} property is relatively lower than the first Q_{g} property.

8. The apparatus of claim 7, the first switching device to be selected for at least one of a heavy load condition and a low frequency condition, and the second switching device to be selected for at least one of a light load condition and a high switching frequency condition.

9. The apparatus of claim 1, the multiple power switching devices comprising uniform cells.

10. The apparatus of claim 1, the multiple power switching devices comprising non-uniform cells.

11. A system comprising:
a power control device comprising multiple power switching devices, one or more of the multiple power switching devices to be selected to dynamically control equivalent parasitic effects of the power control device according to a usage condition; and
a voltage regulator coupled to the power device.

12. The system of claim 11, the usage condition the usage condition comprising at least one of current load (I_{load}), root mean square average current (Iᵣₘₛ), current though the drain-to-source (I_{ds}), input voltage (Vᵢₙ), output voltage (Vₒ), drive voltage across the gate-to-source (V_{gs}), voltage applied across the drain-to-source (V_{ds}), switching frequency (F_{sw}) turn-on time (tₒₙ), and temperature.

13. The system of claim 11, wherein one or more properties of one or more of the power switching devices are dynamically adjusted based on the usage condition.

14. The system of claim 13, the one or more properties comprising at least one of gate charge (Q_{g}), drain-to-source resistance at turn-on (R_{ds}_{_{—}}ₒₙ), switch output capacitance (Cₒₛₛ), and reverse recovery charge (Qᵣᵣ).

15. The system of claim 11, further comprising a controller to select one or more of the multiple power switching devices based on the usage condition.

16. The system of claim 11, further comprising gate driver circuitry to apply adaptive gate voltages to each of the multiple power switching devices based on the usage condition.

17. The system of claim 11, the multiple power switching devices comprising:
a first switching device having a first gate charge (Q_{g}) property and a first drain-to-source resistance at turn-on (R_{ds}_{_{—}}ₒₙ) property; and
a second switching device having a second Q_{g} property and a second R_{ds}_{_{—}}ₒₙ property,
wherein the first R_{ds}_{_{—}}ₒₙ property is relatively lower than the second R_{ds}_{_{—}}ₒₙ property, and the second Q_{g} property is relatively lower than the first Q_{g} property.

18. A method comprising:
determining a usage condition;
adjusting properties of one or more power switching devices; and
selecting one or more of the switching devices according to the usage condition.

19. The method of claim 18, the usage condition comprising at least one of current load (I_{load}), root mean square average current (Iᵣₘₛ), current though the drain-to-source (I_{ds}), input voltage (Vᵢₙ), output voltage (Vₒ), drive voltage across the gate-to-source (V_{gs}), voltage applied across the drain-to-source (V_{ds}), switching frequency (F_{sw}), turn-on time (tₒₙ), and temperature.

20. The method of claim 18, the one or more properties comprising at least one of gate charge (Q_{g}), drain-to-source resistance at turn-on (R_{ds}_{_{—}}ₒₙ), switch output capacitance (Cₒₛₛ), and reverse recovery charge (Qᵣᵣ).

21. The method of claim 18, further comprising sensing usage condition parameters.

22. The method of claim 18, further comprising tracking a load or a variation of the load.

23. The method of claim 18, further comprising dynamically controlling equivalent parasitic effects of the one or more power switching devices.

24. The method of claim 18, further comprising adaptively adjusting one or more operation parameters, switch connections to the one or more switching devices, and physical structures of the one or more switching devices.

25. The method of claim 18, further comprising turning one or more of the switching devices on/off to achieve minimum power consumption for the usage condition.

26. An article comprising a machine-readable storage medium containing instructions that if executed enable a system to:
determine a usage condition;
adjust properties of one or more power switching devices; and
select one or more of the switching devices according to the usage condition.

27. The article of claim 26, further comprising instructions that if executed enable a system to determine a usage condition comprising at least one of current load (I_{load}), root mean square average current (Iᵣₘₛ), current though the drain-to-source (I_{ds}), input voltage (Vᵢₙ), output voltage (Vₒ), drive voltage across the gate-to-source (V_{gs}), voltage applied across the drain-to-source (V_{ds}), switching frequency (F_{sw}, turn-on time (tₒₙ), and temperature.

28. The article of claim 26, the one or more properties comprising at least one of gate charge (Q_{g}), drain-to-source resistance at turn-on (R_{ds}_{_{—}}ₒₙ), switch output capacitance (Cₒₛₛ), and reverse recovery charge (Qᵣᵣ).

29. The article of claim 26, further comprising instructions that if executed enable a system to dynamically control equivalent parasitic effects of the one or more power switching devices.

30. The article of claim 26, further comprising instructions that if executed enable a system to adaptively adjust one or more operation parameters, switch connections to the one or more switching devices, and physical structures of the one or more switching devices.
